(19) United States
(12) Patent Application Publication
(10) Pub. No.: US 2003/0131985 A1
(43) Pub. Date: Jul. 17, 2003

(54) Portable heating and evaporative cooling apparatus

(75) Inventors: Vance Martin Patterson, Morganton, NC (US); Terry Mark Finewood, Charlotte, NC (US); Mark Eugene Moore, Columbia, SC (US); Thomas Leland Henderson, Columbia, SC (US); Michelle Jennings Crosby, Columbia, SC (US); Yuriy Georgiyevich Moskovko, Moscow (RU); Viacheslav Geogiyevich Karadzhi, Moscow (RU)

Correspondence Address: SUGHRUE MION, PLLC, 2100 Pennsylvania Avenue, NW, Washington, DC, 20037-3213, US

(73) Assignee: PATTERSON VENTILATION COMPANY, INC.

(21) Appl. No.: 10/042,361

(22) Filed: Jan. 11, 2002

(51) Int. Cl. F24F 3/14; F25B 13/00; G05D 23/00

(52) U.S. Cl. 165/287; 165/60; 165/62

(57) ABSTRACT

A portable apparatus has a base section that includes a blower, and can be configured for heating or evaporative cooling. By attaching a heating attachment, a gas heating apparatus is provided, and there is no open and/or visible flame. The heating attachment can be replaced with an evaporative cooling attachment, so that evaporative cooling can be performed using the same base with the evaporative cooling attachment. A system of switching pulleys and/or belts to change blower speed, as well as a single switch that operates both devices, is also provided. Thus, a portable heating and evaporative cooling apparatus is provided that has a wide range of industrial application, and that overcomes the related art cost of separate heating and evaporative cooling apparatuses.

### BACKGROUND OF THE INVENTION

1. Field of the Invention

The present invention relates to an apparatus configured for heating and evaporative cooling, and more specifically, a portable device that can be used as a heater and/or an evaporative cooler.

2. Background of the Related Art

In the related art, industrial heating and cooling is accomplished by two separate units. To perform cooling, a related art portable evaporative cooling unit is provided. However, the related art portable cooling unit is not configured to perform heating, and can therefore only be used when temperature conditions require evaporative cooling to a temperature less than that of the ambient air (e.g., summer).

For industrial heating applications, a related art heating unit may be provided. For example, a related art kerosene- or liquid propane-operated heating unit may be used to provide the heat. Therefore, the related art heating unit is only useful during a time period when temperature conditions require heating to a temperature greater than the ambient air temperature (e.g., winter). Due to the fundamentally different structures of the related art heating and evaporative cooling units, there is no related art combined single, portable unit that can perform both heating and cooling in an industrial application.

However, the related art devices have various problems and disadvantages. For example, but not by way of limitation, in the related art, an industrial facility that requires heating and evaporative cooling must purchase the aforementioned separate units, thus incurring additional financial initial purchase costs, as well as storage and maintenance costs for each of the related art units. Also, there is no portable, integral unit that can perform both heating and cooling with a single blower. As noted above, generally, the related art uses two different types of units for heating and evaporative cooling. As a result, there is a high cost associated with maintaining a proper, stable ambient air temperature in industrial facilities.

Further, there is a problem in the related art heater, as related art industrial heaters produce an open, visible flame in the industrial work environment, which increases a risk of industrial accident and reduces the safety of the related art heater.

### SUMMARY OF THE INVENTION

It is an object of the present invention to overcome at least the problems and disadvantages of the related art heating apparatus and evaporative cooling apparatus.

Further, it is an object of the present invention to provide a portable apparatus that can easily be converted between a heating unit and an evaporative cooling unit, and easily operated by a user.

Additionally, it is an object of the present invention to provide a heating unit that does not require an open and/or visible flame, and can be used in a wide range of industrial applications.

To achieve at least the foregoing objects, an apparatus for adjusting ambient air temperature is provided, comprising a single base unit, configured to receive an input at the ambient air temperature and generate a base unit output. The apparatus also comprises a first attachment unit, attachable to the single base unit and configured to receive the base unit output and generate a heated output, and a second attachment unit, attachable to the single base unit and configured to receive the base unit output and output a cooled output generated in the single base unit.

Additionally, a means for adjusting ambient air temperature is provided, comprising a single base means for receiving an input at the ambient air temperature and generating a base unit output, a first attachment means for unit receiving the base unit output and generating a heated output, attachable to the single base unit, and a second attachment means for receiving the base unit output and outputting a cooled output, attachable to the single base unit.

Further, a method of converting an apparatus to a cooling unit from a heating unit is provided, comprising the steps of (a) removing a modular heating shell, (b) electrically disconnecting a heater from the apparatus, (c) removing a modular heating attachment including the heater from the apparatus, (d) mechanically configuring a blower to operate at a predetermined cooling speed, (e) attaching a cooling attachment to the apparatus, and (f) electrically connecting a cooler to the apparatus.

Also, a method of converting an apparatus to a heating unit from a cooling unit is provided, comprising the steps of (a) removing a cooling attachment from the apparatus, (b) attaching a fuel source to the apparatus, (c) mechanically configuring a blower to operate at a predetermined heating speed, (d) attaching a modular heating attachment to the apparatus, and (e) electrically connecting a heater to the apparatus.

Additionally, an apparatus for adjusting ambient air temperature is provided, comprising a single base unit, configured to receive an input at the ambient air temperature and generate a base unit output, and an attachment unit, attachable to the single base unit and configured to receive the base unit output and one of generate one of a heated output and output a cooled output generated in the single base unit.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the invention.

FIGS. 1(a) and 1(b) illustrate front and side views, respectively, of the preferred embodiment of the present invention in a heating mode;

FIGS. 2(a) and 2(c) illustrate front, side and top views, respectively, according to the preferred embodiment of the present invention in an evaporative cooling mode; and

FIG. 3 illustrates relative velocity and temperature on a jet axis for the preferred embodiment of the present invention.

### DETAILED DESCRIPTION OF THE INVENTION

Reference will now be made in detail to the preferred embodiment of the present invention, examples of which are illustrated in the accompanying drawings. In the present invention, the terms are meant to have the definition provided in the specification, and are otherwise not limited by the specification.

The present invention relates to a heater and evaporative cooler, operable in a portable unit. The device can be converted between a heater and an evaporative cooler by exchanging modular attachments that are attachable to a single base unit. A multi-speed blower in the single base unit is used for both heating and cooling. A blower is employed to intake air at a first port, and output air to a second port.

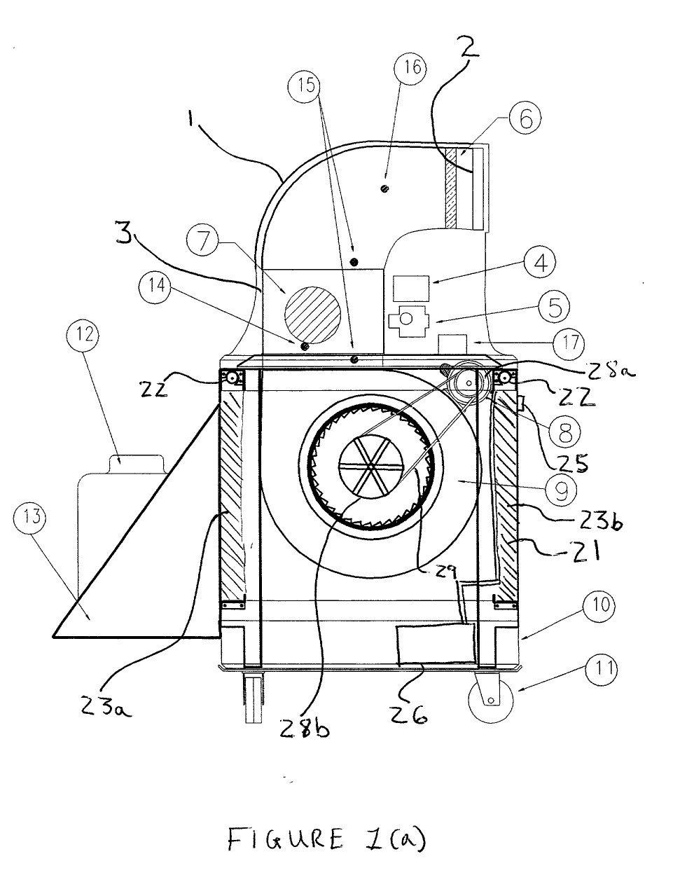

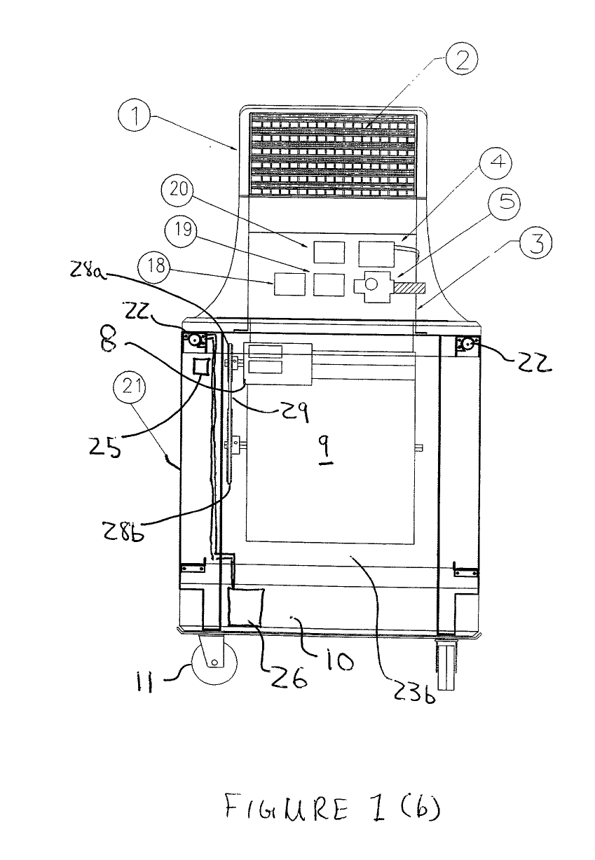

FIGS. 1(a) and 1(b) illustrate the preferred embodiment of the present invention arranged in a heating mode. The apparatus includes a modular heating attachment and a single base unit. The single base unit includes an evaporative cooler frame 21 and a blower 9 powered by a motor 8. A single switch 25, allows the user to operate the present invention in either evaporative cooling mode or heating mode, as described in greater detail below. A conventional fuel supply is provided. As an exemplary embodiment of the conventional fuel supply, a removable fuel tank 12 is positioned on a removable shelf 13, and supplies fuel (preferably liquid propane or natural gas) for heating the air in the heating mode, as described in greater detail below. However, the present invention is not limited to the aforementioned tank 12 and shelf 13 as the conventional fuel supply.

The single base unit also includes a permanently affixed water reservoir 10 for use in the evaporative cooling mode. For evaporative cooling, a drip tube cooler 22 having evaporative cooling medium 23a, 23b is also permanently affixed to the evaporative cooler frame 21 of the single base unit. The evaporative cooling medium 23a, 23b may be positioned on any number of surfaces of the single base unit, preferably on all side surfaces of the single base unit. A sump 26 is attached to the single base unit at the water reservoir 10, and pumps water from the water reservoir 10 to the drip tubes 22. The single base unit also has wheels 11, that allow the apparatus to be portable. Preferably, the wheels 11 have a diameter of about five inches. While the exemplary description of the present invention illustrates a portable apparatus having wheel s 11, the present invention is not limited to being portable, and may also be stationary or mounted in a structure.

In the heating mode, a heater box 3 is attached to the single base unit at the top of the evaporative cooler frame 21, and an outer shell 1 is attached to the heater box 3 and/or the single base unit. While the heater box 3 and related heating mechanism are conventional, the following description merely enumerates the conventional operation thereof. However, the operation of the heater box is not limited to the description contained herein, and any conventional heater box may be applied to the present invention.

An adjustable register 2 is positioned above the heater box 3, the latter receiving air from the single base unit, heating the received air, and outputting heated air at the register 2. Between the register 2 and the heater box 3, a spark arrestor 6 is optionally attached to improve the safety of the apparatus in heating mode.

The outer shell 1 is directly and/or indirectly attachable to a first (e.g., upper) surface of the single base unit. The outer shell 1 is directly attachable to the single base unit by a conventional attachment means including, but not limited to, a bolt, bolts or other fasteners that can be affixed to the single base unit. Preferably, the outer shell 1, having a plurality of (e.g., four) holes, can be bolted to the single base unit. Alternatively, the outer shell 1 may be directly attached to the heater box 3 by conventional attachment means (e.g., bolts and/or screws).

In the present invention, there is no open flame, as the outer shell 1, the heater register 2 and the spark arrestor 6 prevent the user from having access to the open flame. The heater register 2 is attached to the outer shell 1, for example, but not by way of limitation, by screws.

The heater box 3 includes various conventional components that permit operation of the heater box 3. For example, but not by way of limitation, a control system 4 is provided. The control system 4 includes, but is not limited to, an ignition module, a flame sensor module and safety controllers, and is connected to a main control valve 5 that provides fuel to a burner 7 inside the heater box 3. The main control valve 5 is an electronic safety shut-off valve controlled by the control system 4. As the air enters the heater box 3, it passes through the burner 7 and is accordingly heated. The spark arrestor 6 traps any lit debris that passes through the gas burner 7. The gas burner 7 is rated to adjustably provide from about 10,000 to about 250,000 BTU/HR. The flow of fuel can be adjusted by the user via a flow adjustment valve 18. Further, a maximum flow valve 19 is provided that can set the flow rate at a prescribed rate. For example, but not by way of limitation, the flow rate can be factory-set. The user-adjustable control valve 18 allows the customer to set the heat from about 75,000 to about 200,000 BTU/HR. The factory set maximum flow valve 19 limits the burner output to a maximum of about 200,000 BTU/HR.

As a part of the heater box 3, additional conventional components are also provided to measure parameters of the heating unit. For example, but not by way of limitation, an igniter unit 14 that includes at least one igniter and flame sensor is connected to the control system 4. Additionally, a differential pressure sensor 15 and an over-temperature sensor 16 are provided. The control system 4 monitors the differential pressure sensor 15, the over-temperature sensor 16, and the igniter unit 14 for proper operating conditions. A differential pressure control 17 is also provided, for controlling air pressure in accordance with an output of the differential pressure sensor 15. The over-temperature sensor 16 is a safety device that protects against the unit overheating. (e.g., where the ambient air temperature is warm prior to the use of the unit). Also, the differential pressure control 17 ensures that the blower 9 functions properly prior to the operation of the igniter unit 14 and the gas valve.

A transformer 20 is provided that transforms an input voltage from 110 volts to 24 volts, for at least the purpose of ignition of the burner 7. In the present invention, the single switch 25 is attached to the igniter/control system 4, such that the user can operate the present invention in heater mode by transiting the switch 25 to the “ON” position.

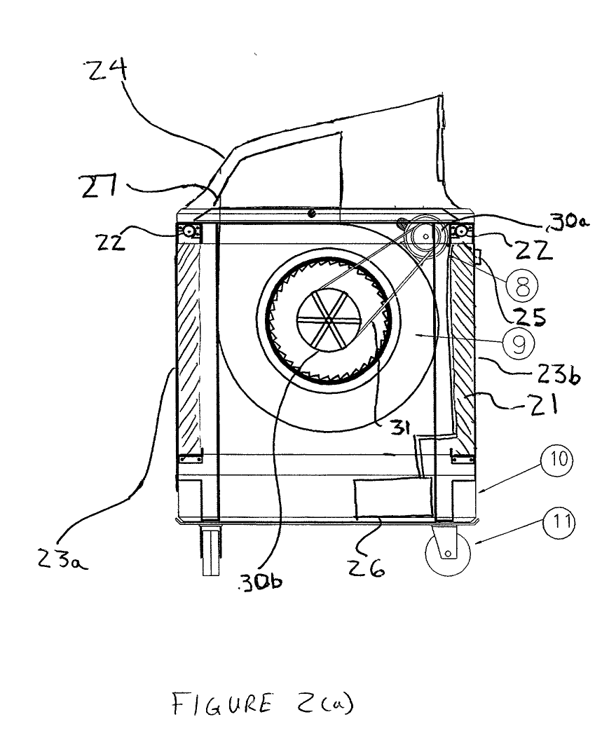

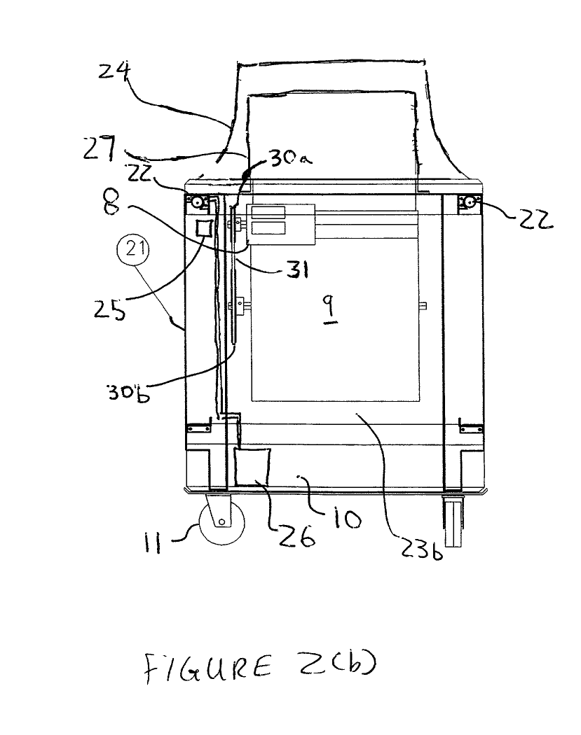

According to the preferred embodiment of the present invention, a second attachment 24 is attachable to the single base unit, so that the apparatus of the present invention may be used as an evaporative cooling unit, as illustrated in FIGS. 2(a) and 2(b). The single base unit including the evaporative cooler frame 21 is used, along with the motor 8, blower 9 and water reservoir 10, as described above. Further, the sump 26 is provided at the base of the single base unit. The user can operate the sump 26 by use of the aforementioned switch 25, which is connected to the sump 26 during evaporative cooling mode. The sump 26 receives water from the water reservoir 10, and pumps the water to drip tubes 22, which are located along the inside corner of the evaporative cooler frame 21, at an upper side. As the water drips down and saturates evaporative cooling medium 23a, 23b within the evaporative cooler frame 21, incoming air is evaporatively cooled.

The blower 9 outputs the air to a cooling attachment 24. The cooling attachment 24 is attached to the single base unit. A snout 27 is attached at an output area of the blower 9, in a manner substantially similar to that described above for the heater box 3. The cooling attachment 24 may be attached directly to the single base unit (for example, but not by way of limitation, by bolts, screws or quick-release fasteners), or the cooling attachment 24 may be attached to the snout 27. The cooling attachment 24, which is substantially shorter than the modular heating attachment, directs the air from a vertical direction of flow to a prescribed angle. As a result, incoming ambient air is evaporatively cooled by being pulled through evaporative cooling medium 23a, 23b.

Due to the difference in the operating speed of the blower 9 in heating and evaporative cooling modes, the pulleys and the blower 9 and motor 8 may be changed in order to change the blower speed. A single pulley system may be employed, such that the user replaces a first set of pulleys 28a, 28b and a first pulley belt 29, as illustrated in FIGS. 1(a) and 1(b), with a respective second set of pulleys 30a, 30b, as illustrated in FIGS. 2(a) and 2(b) of substantially different sizes, as well as a new pulley belt 31 of a substantially different length, in order to increase output of the blower 9 during evaporative cooling mode. Conversely, when the first set of pulleys are used with the corresponding pulley belt, the blower output can be decreased for operation in the heating mode.

Alternatively, a conventional double pulley (not shown) may be provided so that the user can easily switch between pulleys simply by removing the first belt 29 and installing the second belt 31, to permit to blower 9 to operate at a substantially different speed.

As a further alternative, a conventional variable speed pulley system may be employed, to substantially eliminate the need for a user to change pulleys and/or belts during conversion of the apparatus of the present invention between heating mode and evaporative cooling mode.

To convert the present invention from heating mode to evaporative cooling mode, the outer shell 1 of the modular heating attachment, is removed from the single base unit and/or the heater box 3. The single switch 25 is then unplugged from the igniter and flame sensor 14 and safety controllers 4. Then, the heater box 3 is removed from the upper surface of the evaporative cooler frame 21 of the single base unit. Next, the fuel supply is removed. For example, but not by way of limitation, the fuel tank 12 and removable shelf 13 are removed. The shelf 13 is removably attached at an upper edge and a side of the evaporative cooler frame 21 of the single base unit. Because the aforementioned conventional components of the heater box 3 are attached to the heater box 3, those elements are also removed when the heater box 3 is removed.

To change the blower speed for evaporative cooling mode when the aforementioned conventional variable speed pulley system is not used, the pulleys and/or belts are changed from those required for heating mode blower speed to those required for evaporative cooling mode blower speed, as described above. The snout 27 is then attached to the output of the blower 9 of the single base unit in the substantially same manner as described above with respect to the attachment of the heater box 3. Then, the cooling attachment 24 is fastened to the snout 27 and/or the evaporative cooler frame 21 of the single base unit by conventional means including, but not limited to, bolt, screw, quick-release fastener and/or snap-in stud. Alternatively, a single bolt through the center of the top of the cooling attachment 24 may be employed to fasten the cooling attachment 24 to the single base unit. Further, the switch 25, which is attached to igniter 14 and safety controllers 4, is disconnected therefrom and connected to the sump 26. Thus, the user can operate the sump of the present invention in evaporative cooling mode via the single switch 25, which is used to operate the igniter and flame sensor 4 in heating mode.

Conversely, to convert the apparatus from evaporative cooling mode to heating mode, a series of preferred steps is followed, as described below. First, the cooling attachment 24 is removed from the single base unit, followed by removal of the snout 27. Next, the shelf 13 is attached to the single base unit, preferably through use of a conventional clip placed on an upper surface of the evaporative cooler frame 21. At this step, the fuel supply (e.g., fuel tank 12) is added, and the pulleys and/or belts are changed if the aforementioned variable speed pulley system is not employed, so that the blower can operate at the required speed for heating mode. Then, the aforementioned components of the modular heating attachment on the heater box 3 are attached to an upper surface of the evaporative cooler frame 21, and the outer shell 1 is affixed to the heater box 3 and/or the single base unit. Next, the power supply (not shown) is disconnected from the sump 26 and connected to the igniter and control circuit 4, so that a user can operate the present invention in heating mode by use of the single switch 25, which is used to operate the evaporative cooler in cooling mode.

In another alternate preferred embodiment of the present invention, the apparatus may be converted between heating mode and cooling mode without removal of the heating attachment. In this alternate preferred embodiment, the apparatus as illustrated in FIG. 1(a) may be converted from heating mode to cooling mode by disconnecting the power supply from the heating attachment and connecting the power supply to the sump 26, and changing the blower speed to the cooling blower speed as described above. Optionally, the fuel source 12 may be disconnected from the heater box 3. In this alternate embodiment, the outer shell 1, as well as the heater box 3 and its aforementioned conventional components, are not removed during conversion to evaporative cooling mode. Conversely, this alternate embodiment of the present invention can be converted from evaporative cooling mode to heating mode by electrically disconnecting the power supply from the sump and electrically connecting the power supply to the control module 4, and changing the blower speed to the heating blower speed, as described above.

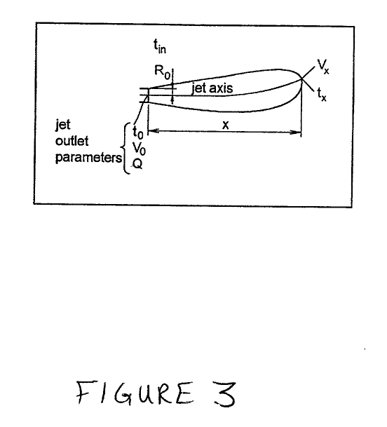

As noted above, in the heating mode, the present invention produces an output of 75,000 to 200,000 BTU/hour. As illustrated in FIG. 3 and described below, the amount of heat required to be added to the air current so that the preferred invention operates as a heater with the heater attachment, and does not generate cold air (i.e., produce a wind chill effect) is calculated based on the following equations.

FIG. 3 illustrates a graph of the below-described theorization of the parameters of the velocity and temperature changes. The parameters along distance x (i.e., velocity Vₓ and temperature difference Δtₓ=tₓ−tᵢₙ) are chosen to be within the limit of Arₓ (Arhimed number), or less than about 0.3 to 0.5, so as to exclude jet rise, as described in Equation (1):

Arₓ=9.81*Δt₁*X/(Vx²*Tᵢₙ)<(range of 0.3 to 0.5) (1)

The relative velocity and temperature, approximated on the jet axis at distance x>0.67*Rₒ/a′ are set equal to one another and can be represented as \overline{V}ₓ=\overline{t}ₓ=1/kₓ, where \overline{V}ₓ=Vₓ/Vₒ and \overline{t}ₓtₓ=Δtₓ/(tₒ−tᵢₙ). Further, as shown in Equation (2):

kₓ=((a′*x/Rₒ)+0.29)/0.96. (2)

Next, the jet outlet parameters are calculated. Jet outlet velocity is set at Vₒ=Vₓ*kₓ, and jet outlet temperature is set at tₒ=tᵢₙ+Δtₓ*kₓ. The temperature rise is Δtₓ=tₓ−tᵢₙ. Additionally, unit parameters for the fan flow rate Q and heat power N necessary to get a temperature rise Δtₓ at distance x are calculated according to Equations (3) and (4), respectively:

Q=II*Rₒ²*Vₓ*kₓ (3)

N=cₚ*II**Rₒ²*Vₓ*kₓ²*ρᵢₙ²(1/(1+(Δtₓ/Tᵢₙ)*kₓ)), (4)

where Tᵢₙ=273+tᵢₙ. In the aforementioned equations, a′ represents a turbulence coefficient (e.g., between about 0.08 and 0.12), x represents a distance along the jet axis, tᵢₙ represents an ambient air temperature in degrees Celsius, and Rₒ represents a cross section radius at the outlet of the present invention. Additionally, tₒ represents jet outlet temperature in degrees Celsius, and Vₒ represents jet outlet velocity in meters per second. As noted above, Q represents fan flow rate in cubic meters per second, and N represents heat power in watts. Further, cₚ represents the specific heat of the air in (J/(kg*° C.), and ρᵢₙ represents air density corresponding to ambient air temperature, and in the present calculations, is set to a constant value of about 1.2 kilograms per cubic meter. Subscript “o” designates a parameter at the outlet and subscript “in” represents a parameter of the ambient (i.e., input) air.

The foregoing equations and parameters are desirable for the present invention to operate most efficiently. For example, but not by way of limitation, to produce a prescribed temperature range over a prescribed distance, the present invention in the heating mode generates a preferred range of about 75,000 BTU/hr to about 200,000 BTU/hr. Those exemplary numerical characteristics of the heated column of air are generated in conformance with the foregoing parameters and Equations (1)-(4), and as illustrated in FIG. 3.

The present invention has various advantages. For example, but not by way of limitation, the present invention includes an apparatus that is portable, including, but not limited to, the context of an industrial facility. Additionally, the present invention is flexible, and can be used for providing heat with the heating attachment, or as an evaporative cooler with the cooling attachment. Further, because the burner is positioned within the heating attachment, the present invention does not produce a visible and/or open flame. Thus, the applicability of the present invention as a heater is expanded over the related art by reducing a risk of fire and related accidental damage.

Additionally, user of the present invention can easily operate the present invention in either heating mode or evaporative cooling mode by use of the switch to turn on either the igniter and safety controllers, or the sump, respectively.

It will be apparent to those skilled in the art that various modifications and variations can be made to the described illustrative embodiments of the present invention without departing from the spirit or scope of the invention. Thus, it is intended that the present invention cover all modifications and variations of this invention consistent with the scope of the appended claims and their equivalents.

What is claimed is:

1. An apparatus for adjusting ambient air temperature, comprising:
a single base unit, configured to receive an input at said ambient air temperature and generate a base unit output;
a first attachment unit, attachable to said single base unit and configured to receive said base unit output and generate a heated output; and
a second attachment unit, attachable to said single base unit and configured to receive said base unit output and output a cooled output generated in the single base unit.

2. The apparatus of claim 1, said single base unit comprising:
a blower that operates in accordance with a motor.

3. The apparatus of claim 1, said single base unit comprising:
a fuel source to provide a heating fuel to said first attachment unit; and
an affixing device to attach said fuel source container to said single base unit.

4. The apparatus of claim 1, said single base unit comprising:
a water reservoir configured to hold a prescribed volume of water;
a sump that pumps said water from said water reservoir to at least one drip source positioned at an upper edge of said single base unit; and
at least one evaporative cooling medium, positioned within a frame of said single base unit, that receives said water from said drip source, wherein said ambient air is evaporatively cooled at said at least one evaporative cooling medium, and said second attachment unit directs said cooled output.

5. The apparatus of claim 1, said first attachment unit comprising:
a burner, positioned in a heater box, that receives and burns fuel to heat said base unit output; and
a register that permits outward flow of said heated output while restricting physical access to said first attachment unit.

6. The apparatus of claim 5, further comprising a spark arrestor that prevents ignited debris produced by said burner from exiting said apparatus with said heated output.

7. The apparatus of claim 1, said first attachment unit comprising:
a control system comprising an ignition module and a flame sensor module, connected to an igniter unit, that monitors at least one differential pressure sensor, an over-temperature pressure sensor and a flame sensor to control a main control valve; and
a differential pressure control configured to control operation of a blower in said single base unit.

8. The apparatus of claim 1, further comprising:
an adjustable flow valve that allows a user to set a heat level in a prescribed range; and
a maximum flow valve that limits said heated output from exceeding a prescribed level.

9. The apparatus of claim 1, wherein a prescribed range of said heated output range is 75,000 BTU/hour to 200,000 BTU/hour, and a maximum level of said heated output is 200,000 BTU/hour.

10. The apparatus of claim 1, wherein apparatus is stationary.

11. The apparatus of claim 1, further comprising wheels that allow movement of said apparatus.

12. The apparatus of claim 1, wherein said apparatus can be converted to a heating mode by connecting a fuel supply to said single base unit and affixing said first attachment unit to said single base unit.

13. The apparatus of claim 1, wherein a power supply is provided to an igniter and at least one control circuit in said first attachment unit.

14. The apparatus of claim 1, wherein a snout is attached to receive said output of said single base unit, said second attachment unit is affixed to one of said single base unit and said snout, in order to convert said apparatus to an evaporating cooling mode, and a power supply is attached to a sump that pumps a water supply through said single base unit.

15. The apparatus of claim 2, wherein at least one first pulley is engaged to operate said blower at a first speed, and at least one second pulley is engaged to operate said blower at a second speed.

16. The apparatus of claim 15, wherein said at least one first pulley and said at least one second pulley are positioned on a double pulley device attached to said blower and said motor, a first belt is configured to be attached to said at least one first pulley and a second belt is configured to be attached to said at least one second pulley.

17. The apparatus of claim 1, further comprising a switch that is attached to said first attachment unit in a heating mode and to a sump in said single base unit in an evaporative cooling mode.

18. The apparatus of claim 3, wherein said fuel source is one of liquid propane and natural gas.

19. A means for adjusting ambient air temperature, comprising:
a single base means for receiving an input at said ambient air temperature and generating a base unit output;
a first attachment means for receiving said base unit output and generating a heated output, attachable to said single base unit; and
a second attachment means for receiving said base unit output and outputting a cooled output, attachable to said single base unit.

20. A method of converting an apparatus to a cooling unit from a heating unit, comprising:
(a) removing a modular heating shell;
(b) electrically disconnecting a heater from said apparatus;
(c) removing a modular heating attachment including said heater from said apparatus;
(d) attaching a cooling attachment to said apparatus; and
(e) electrically connecting a cooler to said apparatus.

21. The method of claim 20, wherein at said (d), a cooling speed of a blower is set to be greater than a heating speed of said blower.

22. The method of claim 20, wherein said (b) comprises electrically disconnecting an igniter and at least one safety controller from said apparatus.

23. The method of claim 20, wherein said (c) comprises removing a heater box and a fuel supply from said apparatus.

24. A method of converting an apparatus to a heating unit from a cooling unit, comprising:
(a) removing a cooling attachment from said apparatus;
(b) attaching a fuel source to said apparatus;
(c) attaching a modular heating attachment to said apparatus; and
(d) electrically connecting a heater to said apparatus.

25. The method of claim 24, wherein at said (c), a heating speed of a blower is set to be greater than a cooling speed of said blower.

26. The method of claim 24, wherein said (d) comprises electrically connecting an igniter and at least one safety controller to said apparatus.

27. An apparatus for adjusting ambient air temperature, comprising:
a single base unit, configured to receive an input at said ambient air temperature and generate a base unit output; and
an attachment unit, attachable to said single base unit and configured to receive said base unit output and one of generate one of a heated output and output a cooled output generated in the single base unit.

28. The apparatus of claim 27, said single base unit comprising:
a blower that operates in accordance with a motor, wherein at least one first pulley is engaged to operate said blower at a first speed, and at least one second pulley is engaged to operate said blower at a second speed;
a detachable fuel source to provide a heating fuel to said attachment unit;
a water reservoir configured to hold a prescribed volume of water;
a sump that pumps said water from said water reservoir to at least one drip source positioned at an upper edge of said single base unit; and
at least one evaporative cooling medium, positioned within a frame of said single base unit, that receives said water from said drip source, wherein said ambient air is evaporatively cooled at said at least one evaporative cooling medium, and said attachment unit directs said cooled output.

29. The apparatus of claim 27, said attachment unit comprising:
a burner, positioned in a heater box, that receives and burns fuel to heat said base unit output; and
a register that permits outward flow of said heated output while restricting physical access to said first attachment unit.

30. The apparatus of claim 27, wherein a power supply is switchably provided to one of:
an igniter and at least one control circuit in said attachment unit; and
a sump that pumps a water supply through said single base unit.
